(19) United States
(12) Patent Application Publication
(10) Pub. No.: US 2003/0222184 A1
(43) Pub. Date: Dec. 4, 2003

(54) Axial oval mount for elongate article having a flexible tie

(75) Inventor: Gerard G. Geiger, Jackson, WI (US)

Correspondence Address: RYAN KROMHOLZ & MANION, S.C., POST OFFICE BOX 26618, MILWAUKEE, WI, 53226, US

(73) Assignee: Hellermann Tyton Corporation

(21) Appl. No.: 10/448,557

(22) Filed: May 30, 2003

Related U.S. Application Data
(60) Provisional application No. 60/384,211, filed on May 30, 2002.

(51) Int. Cl. F16L 3/08

(52) U.S. Cl. 248/65; 248/74.3

(57) ABSTRACT

A mount for securing a flexible tie encircling and bundling an elongate article or articles to a supporting surface. The unitary mount includes a base portion and a support portion. Structures are provided for non-pivotal attachment to a mounting surface. Structure is also provided in an alternate embodiment for permitting the mount to support tied bundles of various diameters. A reinforcing insert may be provided within the base portion.

### RELATED APPLICATION

This application claims the benefit of co-pending provisional patent application serial No. 60/384,211, filed May 30, 2002.

### BACKGROUND OF THE INVENTION

This invention relates generally to hardware for securing bundled elongate articles, such as wires, cables, hoses, tubing, fiber optics, conduits, vines, etc., to a supporting structure. More particularly, the invention relates to a mounting element, engaged by a stud, bolt, screw, rivet, etc., extending from the supporting structure or its facing surface.

Flexible ties are widely used to secure elongate items, such as wires, cables, hoses and tubes, into compact secure bundles. Typically, such ties include a head and a flexible strap which terminates in a tail. In use, the tie is looped around the elongate item and the tail is inserted through the head of a mount, such as a saddle mount. The tail is then pulled tight to pull the strap around the articles, and thereby secure the articles into a compact, neat bundle. A pawl mechanism within the head secures the strap against withdrawal.

In many applications, it is sufficient merely to secure the items into a bundle. Such applications might include, for example, stationary electronic equipment that remains in one place and is subject to little or no vibration in use. In other applications, it is necessary or desirable not only to secure the items into a bundle, but to secure the resulting bundle to a supporting chassis or framework as well. Such applications are also common, for example, in cars, trucks, airplanes, ships, boats and other vehicles where the bundle is likely to be subjected to severe jostling and vibration. In other applications (e.g. buildings), where vibration might not be an important consideration, it is still desirable to secure cables, hoses, tubes, etc., to a fixed structure.

Flexible ties, in and of themselves, are not readily mounted to a supporting structure without the use of additional mounting structures or, in the present case, saddle mounts. Various types of mounts have been proposed. Such mounts are used in conjunction with flexible cable ties and provide an anchor to which the cable tie can be secured in use. Generally, mounting structures can either be entirely formed with a cable tie to create a one-piece structure or they can comprise an element wholly separate from the cable tie. Integrally formed mounting structures result in a one-piece tie that simultaneously secures the wire or similar article into a bundle and allows for securing the resulting bundle to a supporting structure.

### SUMMARY OF THE INVENTION

The present invention provides an improved mount for securing a flexible tie encircling and bundling an elongate article to a supporting surface. The mount comprises a unitary member including an integrally formed base portion and support portion extending outwardly away from the base portion, and wherein the outwardly extending portion includes an aperture for receiving a stud or fastener engagable with a supporting structure, such as a frame rail or similar element. The rear facing surface of the mount may further include a rearwardly extending protrusion for direct engagement with the supporting structure to act as a deterrent for pivoting movement of the mount with respect to the supporting stud.

The present mount also includes a transverse aperture for receiving and supporting a portion of a flexible tie adapted to bundle elongate items, such as wires, cables, hoses, tubing, fiber optics, conduits, vines, etc. The bundling is completed by dimensioning the tie with a headed end and a trailing end, and wherein the headed end includes an aperture with a pawl or the like for receiving the trailing end and permitting the trailing end to be pulled tightly therethrough as it encircles and bundles the hardware to be secured.

Alternatively, the present invention may include a metal bushing insert provided in the aperture for receiving the stud or fastener. The metal bushing insert is provided to supply additional reinforcement and therefore allow additional torque to be applied during securement to a supporting structure. The metal bushing is preferably formed from a low alloy steel or from a powdered metallurgy process.

It is therefore the principle object of the present invention to provide a securing means for minimizing the pivotal movement of an apertured mount as it is anchored on a stud member, such as a screw, a bolt and nut combination or a headed nail protruding from a supporting structure.

It is a further object of this invention to provide an apertured mount including a base portion defining an arched under surface and a transverse opening and including a notched out area intermediate the ends of said under surface. This configuration permits alternative application of the mount for use with bundled elongate objects having relatively different circumferences, the larger circumference being accommodated by a major portion of the arched under surface, whereas a relatively smaller diameter bundle being accommodated by the intermediate area and having its bundle tie through an integrally formed and cooperating locking pawl.

In an alternative embodiment the mount includes a reinforcing insert located in the aperture. The insert provides additional support and strength to the mount for receiving and supporting a stud or fastener engagable with a supporting structure. The insert preferably includes an inner surface for supporting contact with a fastener, and an outer surface for supporting engagement with the surface of the aperture. Further, the alternative embodiment mount may include a supporting surface

### DESCRIPTION OF THE DRAWINGS

The invention, together with the further objects and advantages thereof, may best be understood by reference to the following description taken in conjunction with the accompanying drawings, wherein like reference numerals identify like elements, and wherein:

FIG. 1 is a perspective view of the mount embodying the various features of this invention.

FIG. 2 is a rearward perspective view taken from a point below the mount as illustrated in the view of FIG. 1.

FIG. 3 is a front facing elevational view of the mount of this invention.

FIG. 4a is a cross sectional view of the mount taken along lines 4-4 of FIG. 3, and as further depicted in anchoring relationship with a supporting structure, such as a vehicle chassis frame, or the like.

FIG. 4b is a cross sectional view of an alternate mount taken along lines 4-4 of FIG. 3, and as further depicted in an alternate anchoring relationship with a supporting structure, such as a wall or a vehicle chassis frame, or the like.

FIG. 5 is a cross sectional view taken along lines 5-5 of FIG. 4b, and further indicating a relationship, in phantom fragmentary view, of a mount with flexible strap and further shown in phantom in connection with bundling a plurality of elongate objects.

FIG. 6 is a perspective view of an alternative embodiment of this invention.

FIG. 7 is a plan view of the mount of the invention as disclosed in FIG. 6.

FIG. 8a is a cross-sectional view taken along lines 8a-8a of FIG. 7 and further disclosing, in phantom view a bundle of elongated objects of relatively large diameter seated adjacent the mount.

FIG. 8b is a cross-sectional view taken along lines 8b-8b of FIG. 7 and illustrating a bundle of tied elongated objects of lesser diameter which may be held in place by the alternative constructive mount of this invention.

FIG. 9 is a perspective view of an alternative embodiment of this invention showing a metal bushing insert.

FIG. 10 is a top plan view of the mount shown in FIG. 9.

FIG. 11 is a bottom plan view of the mount shown in FIGS. 9 and 10.

FIG. 12 is a cross sectional view taken along lines 12-12 of FIG. 10 and as further depicted in anchoring relationship with a supporting structure with flexible strap in connection with bundling an elongate object shown in phantom.

FIG. 13 is an exploded view of an alternative embodiment mount similar to that shown in FIG. 9, but showing an alternative metal bushing insert.

FIG. 14 is a cross sectional view taken along lines 14-14 of FIG. 13 and showing the alternative bushing insert in place in the mount.

FIG. 15 is an exploded view similar to that of FIG. 13 but showing another alternative embodiment metal bushing insert.

FIG. 16 is a cross sectional view taken along lines 16-16 of FIG. 15 and showing the metal bushing insert in place in the mount.

FIG. 17 is an exploded view similar to that of FIGS. 13 and 15 but showing another alternative embodiment metal bushing insert.

FIG. 18 is a cross sectional view taken along lines 18-18 of FIG. 17 and showing the metal bushing insert in place in the mount.

FIG. 19 is an exploded view similar to that of FIGS. 13, 15 and 17 but showing yet another alternative embodiment metal bushing insert.

FIG. 20 is a cross sectional view taken along lines 20-20 of FIG. 19 and showing the metal bushing insert in place in the mount.

FIG. 21 is an exploded view similar to that of FIGS. 13, 15, 17, and 19 but showing still another alternative embodiment metal bushing insert.

FIG. 22 is a cross sectional view taken along lines 22-22 of FIG. 21 and showing the metal bushing insert in place in the mount.

### DETAILED DESCRIPTION

Although the disclosure hereof is detailed and exact to enable those skilled in the art to practice the invention, the physical embodiments herein disclosed merely exemplify the invention that may be embodied in other specific structure. While the preferred embodiment has been described, the details may be changed without departing from the invention, which is defined by the claims.

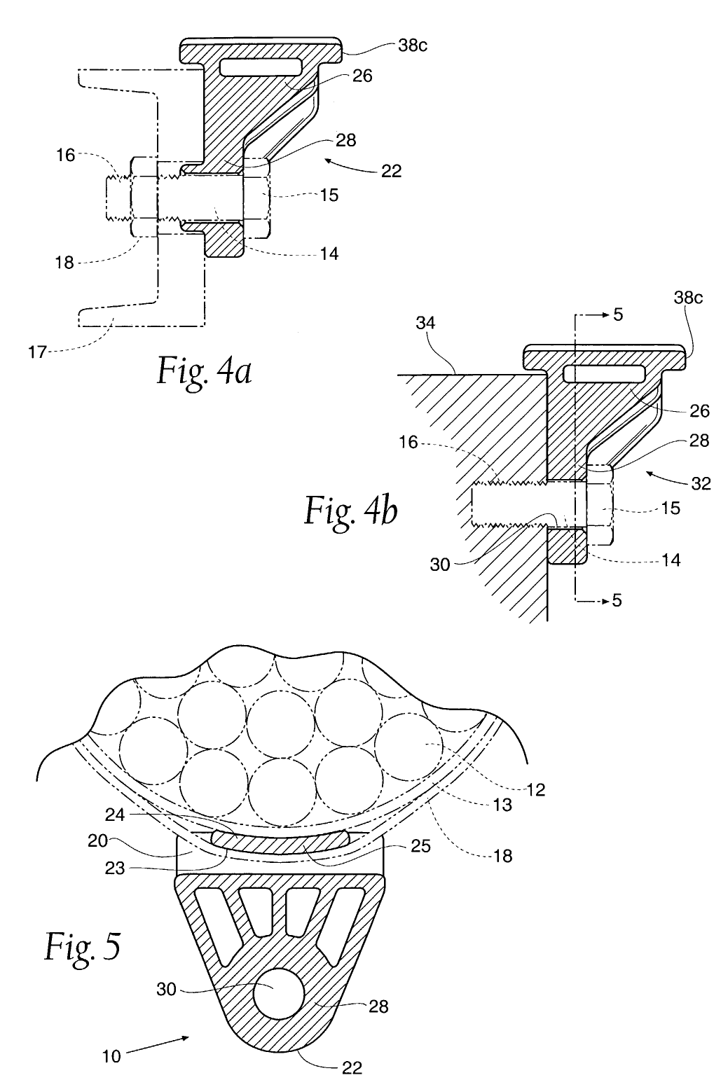

A flexible tie mounting system, shown generally by the reference character 10, embodying various features of the present concept, is shown in particular, in connection with FIG. 5. As illustrated, the system 10 is used to secure elongate elements or items, such as adjacent strands of wire, conduit or fiber optics strands 12 (herein shown in phantom, encased in an outer tubular conduit 13), to a supporting structure 34 by means of an outwardly projecting mounting element 14 having a head 15 and a threaded shaft 16 (see phantom lines in FIGS. 4a and 4b). The shaft 16 with head 15 and nut 18 may be a conventional threaded bolt and nut, a screw or a stud (not shown). For illustrative purposes, the supporting structure 34 may also be the frame rail 17 (see FIG. 4a) of a truck or similar vehicle subject to jostling as the vehicle moves along bumpy roads or subjected to other rough usage. It will be appreciated that the system 10 may be used in other applications, and can be used to mount other tie bundled items to any form of a supporting structure 34 utilizing a mounting element, such as a stud, bolt, screw, threaded rod, rivet, nail, etc.

A portion of a flexible tie 18, as shown in phantom in FIG. 5, has been passed through a transverse aperture 20 of the mount 22 of the present invention. The flexible tie 18 is supported by the inner surface 23 of a wall member 24. The arched exterior surface 25 of the wall member 24 supports the bundled element 12, 13.

With particular attention to the mount 22, as shown in FIGS. 4a and 4b, it will be noted that the mount 22 is provided with an integral base portion 26 having an upstanding, laterally extending support portion 28. The upwardly extending portion 28 includes an aperture 30 arranged to receive the mounting element 14 illustrated herein to be in the form of a threaded bolt having the head 15 and threaded shaft 16 engageable with a threaded opening in the supporting structure 34. Again, the threaded bolt 14 is shown for illustrative purposes only. This projecting mounting element 16, may also take the form of a bolt, screw, threaded rod, rivet, mounting stud, etc. or similar item.

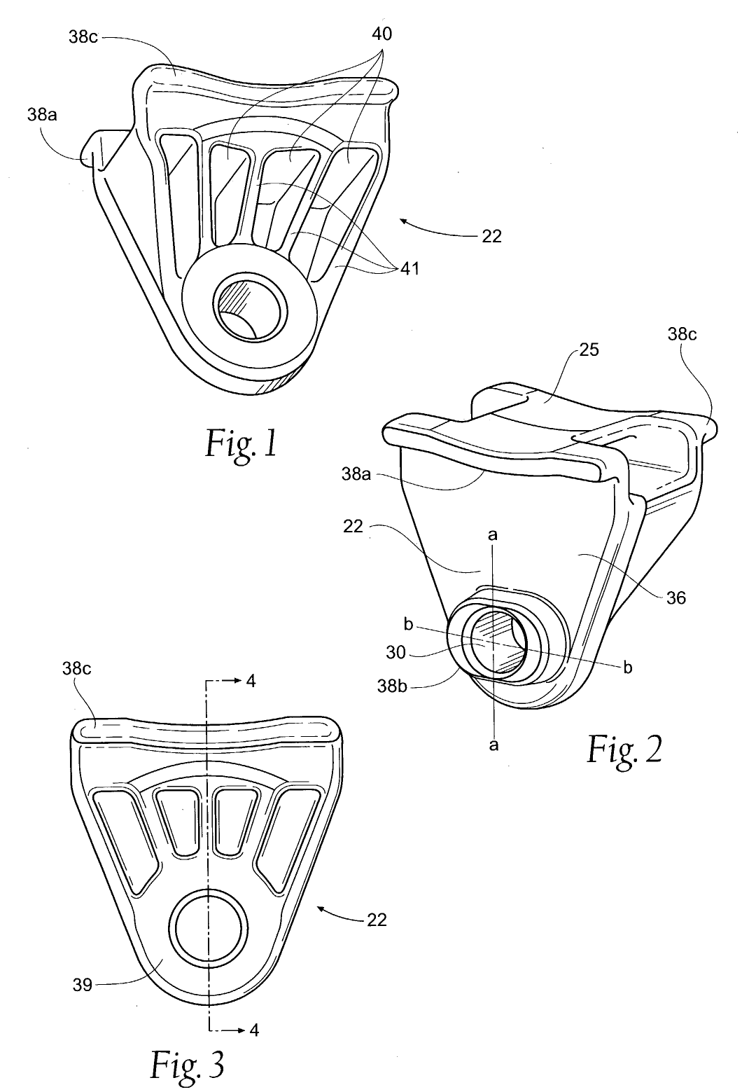

In one embodiment, the mount 22 further includes, at its rear surface 36 protrusions 38a, 38b and 38c (see FIG. 2 and FIG. 4a). The protrusions 38a, 38b and 38c are each laterally spaced from the aperture 30. The protrusions 38a and 38c take the form of a ledge extending outwardly from the inner surface 36 of the mount 22. These ledges, or flanged protrusions 38a and 38c extend across the mount 22 to provide a surface for engaging the supporting structure 34, as does the generally oval shaped protrusion 38b surrounding the aperture 30. The protrusions 38a and/or 38b and/or 38c act to provide a means for minimizing rotation of the mount 22 around its aperture 30 when supported by the mounting element 14. The external dimensions of the protrusions 38a, 38b and 38c are relatively thin when compared to the inner facing surface 36 of the mount 22. This relationship permits tight clamping engagement of the mount 22 with the supporting structure 34. When the head 15 of the mounting element 14 is tightened to engage and urge the mount 22 towards the supporting structure 34. In the case of a relatively soft wooden supporting structure 34, the protrusions 38a and 38b may actually penetrate the surface of the wooden wall 34. With a metal frame rail 17, the protrusions 38a and 38b fit within a mating opening to minimize rotation of the mount 22 around the supporting stud or other mounting element 14. Such action will act to stabilize the bundled elements 12 relative to the mounting surface 17.

An alternate embodiment of the invention 32 is shown in FIG. 4b. In this embodiment, the protrusion 38b has been removed. The mount 32 is again secured to the mounting surface 34, but relies on the frictional interface between the mount 32 and surface 34 for rotational stability.

The present invention also contemplates the use of only one protrusion, either 38a or 38b or 38c, so long as it is spaced from the aperture 30. This design, when dimensioned properly, will provide a lever arm adding to the torque required to pivotally move the mount 22 relative to the wall 34 of frame rail 17.

It will be noted that the rearwardly extending protrusion 38b includes a minor axis “a-a” and a major axis “b-b” (see FIG. 2). The major axis “b-b” of the oval protrusion 38b lies substantially parallel with the lower surface of the ledge protrusion 38a to provide additional interference with the ledge 38a when the mounting element 16 has been tightened with its head 15 tightly engaging the front surface of the mounting 22. This arrangement will provide a secure anchoring surface with respect to a supporting structure 34 as shown in FIG. 4.

Although the preferred embodiment utilizes a generally oval shaped enclosed protrusion surrounding the aperture 30 it will be apparent that protrusions of other configurations may be substituted and remain within the province of the present invention.

With particular attention to FIGS. 2 and 5, it will be observed that the ledge or flanged portions 38a and 38c also provide an extension of the wall member 24 of the mount 22, with its lower surface 25 being curved or arched to provide a contacting surface for further support of the bundled element 12.

As shown in FIGS. 1 and 3, the front face of the mount 22 is preferably molded with a series of re-entrant openings 40 separated by webs 41. The openings 40 are designed to reduce the amount of resin needed for injection molding, without sacrificing strength of the integrally molded mount 22.

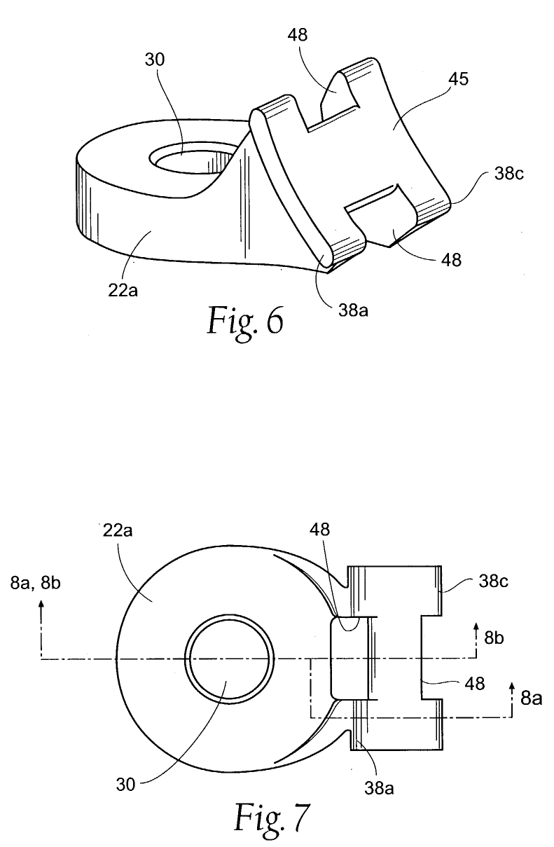

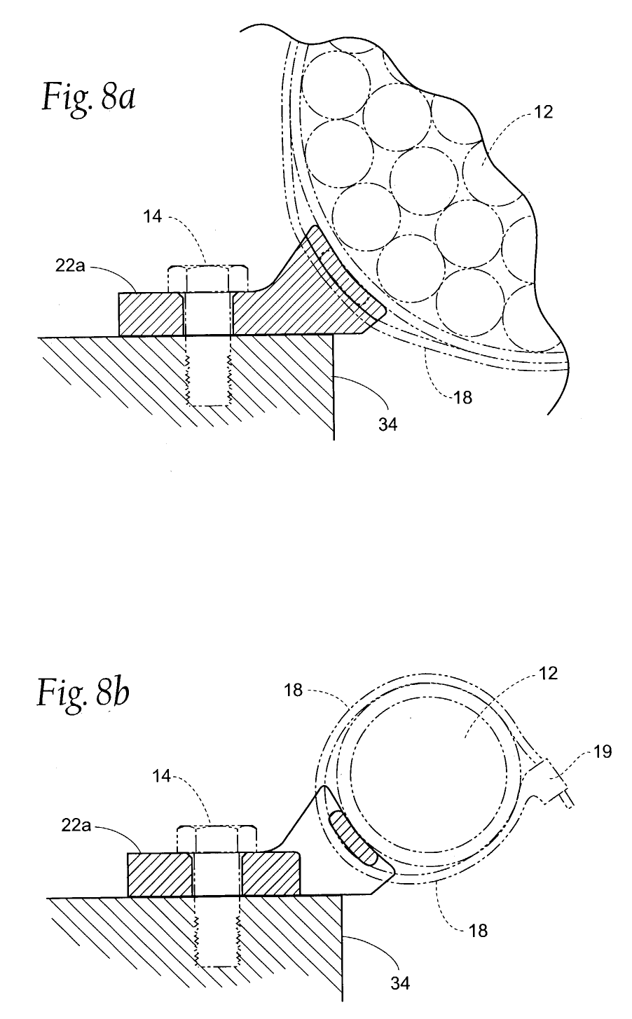

Another embodiment of the present invention will next be explained with respect to the views of FIGS. 6-22, inclusive. With particular attention to FIG. 6, it will be noted that a mount 22a of similar construction to the mount 22 has been provided. There is the opening 30 arranged to accommodate a mounting element such as a stud 14 shown in phantom in the views of FIGS. 8a and 8b. As previously described, the stud is intended to engage a threaded opening in a supporting structure, such as a wall 34.

As will be noted, the present embodiment includes a supporting surface 45 of a relatively expanded arcuate dimension suitable for supporting a relatively large bundle of tie bundled objects 12 as shown in FIG. 8a. The surface 45 extends at opposite ends to define outwardly projecting flanged areas 38a and 38c, and notched out areas 48. The notched out areas 48, as shown in FIG. 8b, will accommodate a bundle of relatively small diameter when compared with the relatively larger bundle 12 of FIG. 8a. The tie 18 of standard width may be used to bundle either of the buckled objects 12, whether of enlarged diameter or of the smaller diameter shown in FIG. 8b. The flexible tie 18 will be pulled through its locking means 19 to the desired diameter and will be latched in place by an inner pawl (not shown) as is well known in the art. Proper support will be provided by this embodiment, no matter the diametrical size of the bundle to be supported by the mount 22a.

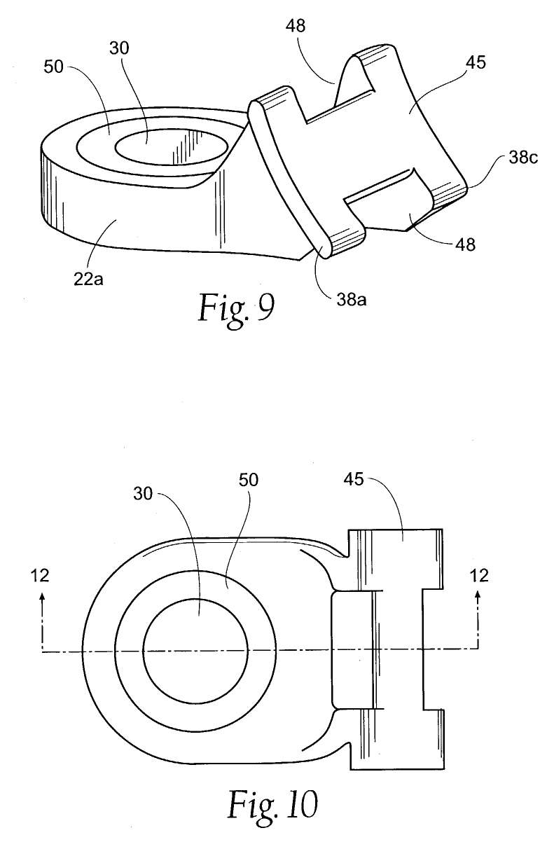

As shown in FIGS. 9-22, an insert 50 may be molded or placed within the opening 30. In my preferred embodiment, the insert 50 is formed from a metallic material such as low alloy steel or formed from a powder metallurgy process. The insert provides the benefit of allowing the mounting element 14 to be tightened to a predetermined torque that is higher than the torque permissible without the insert 50. In other words, without insert 50 the mount 22a may deform, collapse or fail if the mounting element torque exceeded a certain level. Including the insert 50 allows the torque to be sufficiently greater without causing damage to the mount 22a.

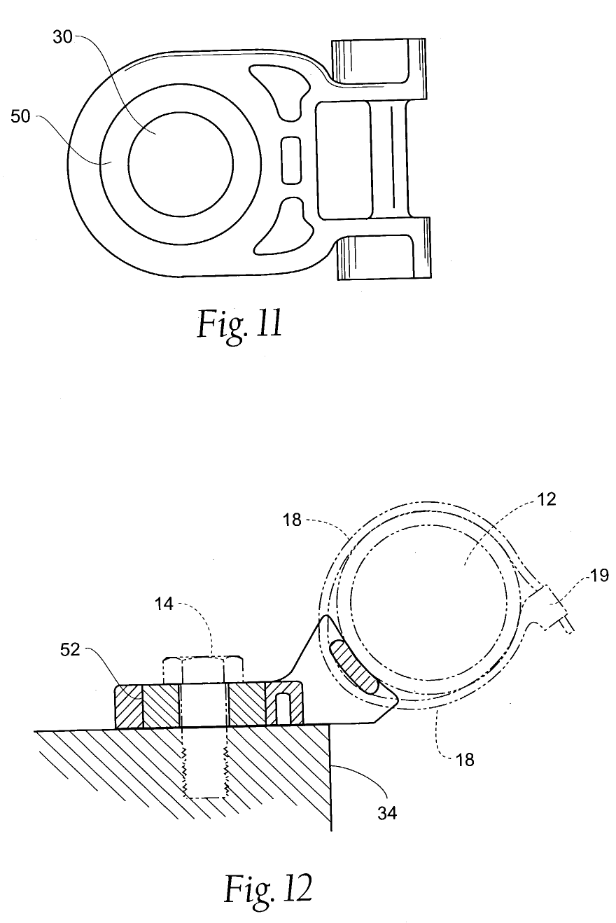

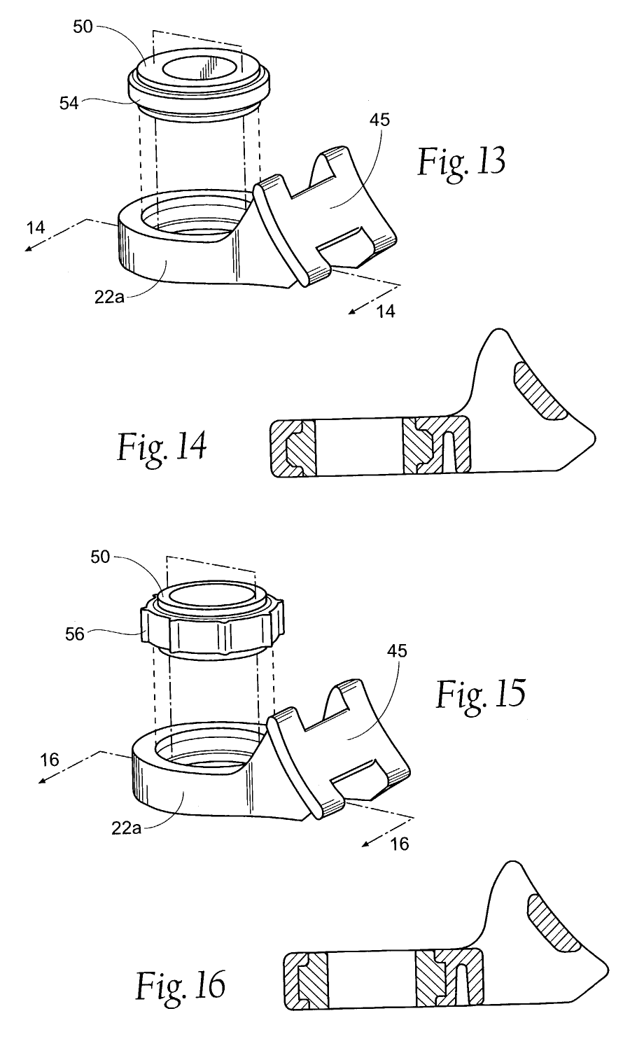

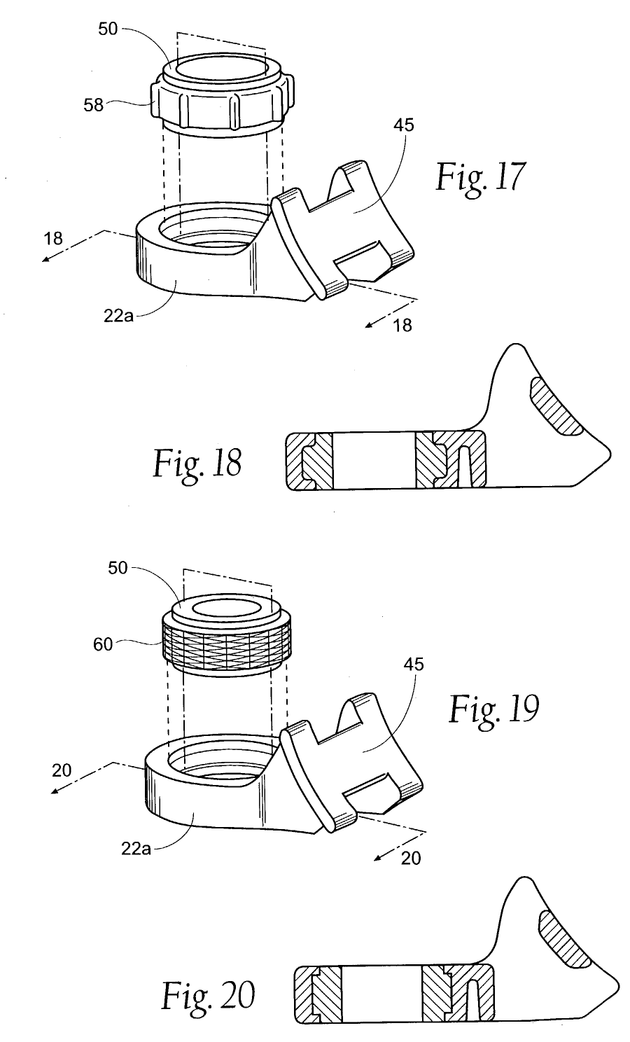

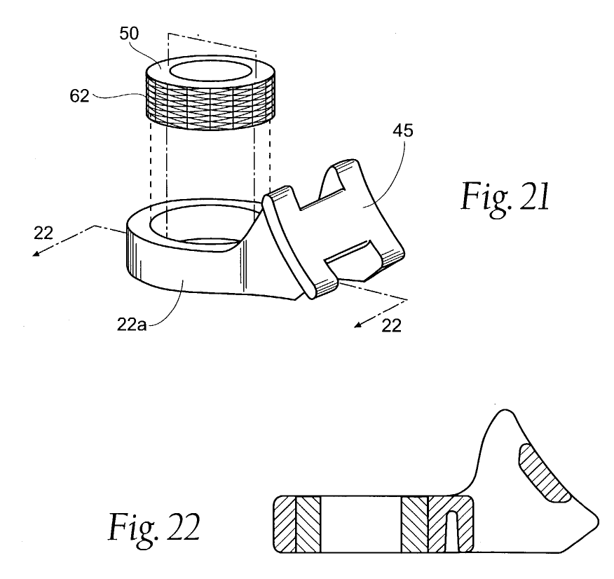

As best shown in FIG. 12, the insert 50 may have an annular shape including substantially smooth outer walls 52. The insert may be either press fit into the mount 22a or may be integrally molded therein. As shown in FIGS. 13 and 14, the insert 50 may include a secondary annular protrusion 54 to retain the insert within the mount 22a. As shown in FIGS. 15 and 16, the inset may include laterally spaced, triangular protrusions 56 along the outer surface of the insert 50. As shown in FIGS. 17 and 18, the insert may include laterally spaced, semi-cylindrical protrusions 58 along the outer surface of the insert 50. As shown in FIGS. 19 and 20, the insert may include a secondary annular protrusion having a knurl 60 formed thereon. As shown in FIGS. 21 and 22, the insert may include simply a knurl 62 formed along the full height of the outer surface of the insert 50.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

What is claimed is:

1. A mount for anchoring a bundled elongate member having an encircling flexible tie to a supporting structure;
said mount comprising a unitary structure with front and rear facing surfaces and including a base portion and a support portion extending laterally away from the base portion;
said support portion including proximate to its outermost end a supporting aperture for receiving a mounting element;
said mounting element having a head engagable with the front facing surface of said mount and a shaft arranged for sliding engagement with said aperture and being further arranged for anchoring engagement with said supporting structure;
the rear facing structure of said mount including at least one rearwardly extending protrusion spaced from said aperture and engagable with a mating surface of said supporting structure and with sufficient force to minimize lateral motion of the mount with respect to said supporting structure when said head has been positioned in tight securing engagement with said supporting structure; and
said base portion of said mount including a transverse aperture arranged to receive and support a portion of said flexible tie during encircling engagement of said flexible tie with said elongate member

2. The mount of claim 1, wherein said mounting element includes a threaded shaft and a threaded nut arranged to draw said shaft and said head towards said mount and said supporting structure with sufficient force to minimize pivotal movement of said mount and its protrusion with respect to said supporting structure.

3. The mount of claim 1, wherein a reinforcing insert is located within the supporting aperture.

4. The mount of claim 1, wherein the rear facing surface of said mount includes a protrusion laterally spaced from said aperture and defining a flanged ledge portion extending laterally from said transverse aperture to define an arched surface engagable with a surface of said bundled elongate member.

5. The mount of claim 1, wherein the rear facing surface of said mount includes a protrusion defining an enclosed, continuous coaxial ring spaced from and surrounding said supporting aperture, said coaxial ring defining a general oval-shaped configuration.

6. The mount of claim 1, wherein the rear facing surface of said mount including a protrusion laterally spaced from said supporting aperture and defining a flanged ledge portion extending laterally from said transverse aperture to define an arched surface engagable with a surface of said bundled elongate member.

7. The mount of claim 6, wherein the rear facing surface of said mount further includes a protrusion defining an enclosed, continuous coaxial ring spaced from and surrounding said supporting aperture, said coaxial ring defining a general oval-shaped configuration.

8. The mount of claim 7, wherein the major axis of said oval-shaped coaxial ring lies in a plane substantially parallel with the plane of the flanged ledge portion.

9. A mount for anchoring a bundled elongate member having an encircling flexible tie to a supporting structure,
said mount comprising a unitary structure and including a base portion and a support portion extending laterally away from the base portion,
said support portion including a supporting aperture for receiving a mounting element for anchoring an engagement of said mount with said supporting structure,
said base portion of said mount including a transverse aperture arranged to receive and support a portion of said flexible tie during encircling engagement of said tie with said elongate member,
said base portion of said mount further including an arcuate surface spaced from said transverse aperture and arranged for supporting engagement with an arcuate surface of said bundled elongate member, and
said mount arcuate surface defining a supporting portion intermediate its ends and arranged for receiving and substituting a bundled elongate member of lessor diameter than the diameter of the arcuate surface of said first-mentioned bundled elongate member.

10. The mount of claim 9, wherein said intermediate supporting portion is defined by oppositely disposed notched areas formed in said base portion.
